(19) United States
(12) Patent Application Publication
(10) Pub. No.: US 2023/0230188 A1
(43) Pub. Date: Jul. 20, 2023

(54) INCIDENT RESPONSE SYSTEMS AND METHODS

(71) Applicant: INFINITE BLUE IP, LLC, Audubon, PA (US)

(72) Inventor: Michael J. Sher, New York, NY (US)

(21) Appl. No.: 17/994,790

(22) Filed: Nov. 28, 2022

Related U.S. Application Data
(63) Continuation of application No. 16/025,547, filed on Jul. 2, 2018, now abandoned.
(60) Provisional application No. 62/527,218, filed on Jun. 30, 2017.

(51) Int. Cl. G06Q 50/26; G06Q 10/0631; H04W 4/90; G06Q 10/1093

(52) U.S. Cl. CPC G06Q 50/265; G06Q 10/063114; H04W 4/90; G06Q 10/1097; G06F 3/04842

(57) ABSTRACT

The present disclosure relates to a networked environment for incident response. In accordance with one aspect, a central system for incident response includes an electronic storage that stores an incident response template having time-relative tasks and contact information for an incident response team, a communication device configured to communicate with a plurality of devices corresponding to at least some of the contact information, one or more processors, and at least one memory storing instructions. The devices include a lead device and mobile devices. The instructions, when executed by the processor(s), cause the central system to receive via the communication device an activation of the incident response template from the lead device at an activation time, schedule an activated incident response based on the activation including scheduling the time-relative tasks based on the activation time, and communicate via the communication device with the mobile devices regarding the activated incident response.

### CROSS-REFERENCE TO RELATED APPLICATIONS

The present application is a continuation of U.S. patent application Ser. No. 16/025,547, filed Jul. 2, 2018, which claims the benefit of and priority to U.S. Provisional Application No. 62/527,218, filed Jun. 30, 2017. The entire contents of each of the foregoing applications are hereby incorporated by reference herein in their entirety.

### TECHNICAL FIELD

The present disclosure relates to incident response, and more particularly, to a networked environment for responding to an incident.

### BACKGROUND

Planning is of utmost importance in responding to incidents, and in responding to crisis incidents in particular. Poor planning can mean loss of lives in the worst case, and other types of losses in other cases, including financial loss, property loss, loss of reputation, or loss of trust, among other things. However, planning is only part of the equation. An effective incident response requires proper execution, which presents many logistical challenges. Communication and coordination between incident response team members presents one of the biggest challenges. For example, miscommunication or lack of communication between incident response team members can be determinative of the outcome of an incident response, especially at critical junctures of a response. Existing incident response solutions have not adequately addressed the logistical issues around miscommunication or lack of communication. Existing solutions also do not provide or adequately provide combined mechanisms for coordinating the actions of multiple responders, tracking and measuring results, saving associated information, and providing for a post mortem analysis. Further, the requirements of effective incident response management are not well met by traditional event-planning, data recording and analysis, or tracking systems, such as Microsoft® Excel®, Atlassian® Jira®, or systems primarily designed to track IT-related incidents. Accordingly, there is continuing interest in developing and improving technologies for effectively responding to incidents.

### SUMMARY

The present disclosure relates to a networked environment for incident response. The wide adoption of smartphones and other mobile devices has provided the environment for an incident response management system with far more effective performance in the challenging and dynamic conditions that ensue when an incident occurs. One aspect of the present disclosure is directed to a central system in the cloud that coordinates and logs communications between team member devices and maintains the status of response tasks. Team member devices interact with the response tasks and communicate local actions to the central system. The central system aggregates, organizes, and logs the local actions from the team members' devices to centrally coordinate the incident response and update the status of the response tasks. Additionally, the central system can be provided with application programming interfaces (APIs) that enable remote systems to receive or transmit data for display or storage for communicating with third party systems and/or to control various functions of the app on one or more remote clients.

In accordance with one aspect of the present disclosure, a central system for incident response includes an electronic storage storing information including an incident response template having time-relative tasks and contact information for an incident response team, a communication device configured to communicate with a plurality of devices corresponding to at least some of the contact information, one or more processors, and at least one memory storing instructions. The devices include a lead device and mobile devices. The instruction, when executed by the one or more processors, cause the central system to receive via the communication device an activation of the incident response template from the lead device at an activation time, schedule an activated incident response based on the activation of the incident response template wherein scheduling the activated incident response includes scheduling the time-relative tasks based on the activation time, and communicate via the communication device with the plurality of mobile devices regarding the activated incident response.

In various embodiments, the instructions, when executed by the one or more processors, further cause the central system to invite the mobile devices to join the activated incident response, receive confirmation that the mobile devices have joined the activated incident response, and communicate with the mobile devices regarding the scheduled time-relative tasks.

In various embodiments, at least one of the mobile devices joins the activated incident response as a participant, and the instructions, when executed by the one or more processors, further cause the central system to receive from the at least one mobile device at least one action at the at least one mobile device relating to the scheduled time-relative tasks, update in real-time the activated incident response based on the at least one action at the at least one mobile device, and communicate in real-time the updated activated incident response to the plurality of mobile devices.

In various embodiments, the at least one action includes attaching a file to a task of the scheduled time-relative tasks at the at least one mobile device, where receiving the at least one action includes receiving the file, updating the activated incident response includes storing in the electronic storage the file and an association of the file with the task, and communicating the updated activated incident response includes communicating to the mobile devices the file and the association of the file with the task.

In various embodiments, the electronic storage includes a list of authorized file types including at least one of a video file, an image file, an audio file, an audiovisual file, a photograph file, or a document file, and the file is of a type included in the list.

In various embodiments, at least one action includes designating, at the at least one mobile device, at least one of the schedule time-sensitive tasks as being completed, and/or incorporating information about performance or outcome into at least one of the schedule time-sensitive tasks.

In various embodiments, the invitation is an invitation to observe, and at least one of the mobile devices joins the activated incident response as an observer in response to the invitation to observe.

In various embodiments, the instructions, when executed by the one or more processors, further cause the central system to communicate with the mobile devices regarding the scheduled time-relative tasks, and receive from the mobile devices actions at the mobile devices relating to the scheduled time-relative tasks, where the received actions include time-stamps indicating times at which the actions occurred at the mobile devices, and the time-stamps are provided by the mobile devices.

In various embodiments, the instructions, when executed by the one or more processors, further cause the central system to determine a temporal sequence of actions relating to the scheduled time-relative tasks based on the time-stamps of the actions, and store in the electronic storage the temporal sequence of actions. In various embodiments, the temporal sequence of actions includes an earlier action and a later action that at least partially negates the earlier action, and both the earlier action and the later action are stored in the electronic storage as part of the temporal sequence of actions.

In various embodiments, the instructions, when executed by the one or more processors, further cause the central system to receive from the lead device via the communication device an activation of a previously inactive user interface button for the activated incident response, and communicate via the communication device with the mobile devices regarding the activated user interface button for the activated incident response. In various embodiments, the activated user interface button is a map access button. In various embodiments, the activated user interface button is a group information logging portal button.

In various embodiments, the instructions, when executed by the one or more processors, further cause the central system to receive from the lead device via the communication device an activation of a teleconference for the activated incident response, initiate a teleconference including the lead device, initiate voice calls to the mobile devices using the contact information, and add to the teleconference any of the mobile devices which answer the voice calls.

In various embodiments, the instructions, when executed by the one or more processors, further cause the central system to record audio conversation in the teleconference, convert the audio conversation into a text transcription of the audio conversation using machine transcription, and store the text transcription of the audio conversation in the electronic storage.

In various embodiments, the instructions, when executed by the one or more processors, further cause the central system to maintain the teleconference as long as the activated incident response remains active, and permit teleconference participants to join and drop off the teleconference while it is maintained.

In various embodiments, the time-relative tasks include a precursor task and a dependent task that depends on the precursor task, wherein the instructions, when executed by the one or more processors, further cause the central system to prohibit any user interaction with the dependent task until the precursor task is completed, and permit user interaction with the dependent task when the precursor task is completed.

In various embodiments, the electronic storage further includes roles and privileges associated with members of the incident response team. Each of the time-relative tasks is associated with a particular role or a particular person, and the instructions, when executed by the one or more processors, further cause the central system to permit the time-relative tasks to be completed only by the particular persons or by members of the incident response team who are associated with the particular roles associated with the time-relative tasks.

In various embodiments, the electronic storage further includes a list including at least one of authorized organizations, devices, or users, and authentication credentials for members of the list, and the instructions, when executed by the one or more processors, further cause the central system to prohibit access to the activated incident response by anyone who is not included in the list.

In accordance with aspects of the present disclosure, a mobile apparatus for incident response includes a display screen, a communication device, an electronic storage storing a mobile app configured to communicate with an incident response central system using the communication device, one or more processors, and at least one memory storing instructions corresponding to the mobile app. The instructions, when executed by the one or more processors, cause the mobile apparatus to, receive via the communication device an invitation from the central system to join an activated incident response as a participant, send via the communication device an acceptance of the invitation, receive via the communication device scheduled time-relative tasks corresponding to the activated incident response, and display the scheduled time-relative tasks on the display screen.

In various embodiments, the mobile apparatus further includes a user input device, and the instructions, when executed by the one or more processors, further cause the mobile apparatus to receive via the user input device a user action for the scheduled time-relative tasks, associate a time-stamp with the user action, and communicate in real-time with the central system regarding the user action and the associated time-stamp.

In various embodiments, the user action includes attaching a file to a task of the scheduled time-relative tasks, and communicating with the central system includes communicating the file to the central system. In various embodiments, the electronic storage includes a list of authorized file types including at least one of a video file, an image file, an audio file, an audiovisual file, a photograph file, or a text document file, and the file is of a type included in the list.

In various embodiments, the instructions, when executed by the one or more processors, further cause the central system to receive from the central system via the communication device an activation of a previously inactive user interface button for the mobile app, and display the activated user interface button in the mobile app on the display screen. In various embodiments, the instructions, when executed by the one or more processors, further cause the central system to, prior to receiving the activation of the user interface button, not display the user interface button in the mobile app on the display screen. In various embodiments, the user interface button is a map access button in the mobile app.

In various embodiments, the instructions, when executed by the one or more processors, further cause the mobile apparatus to: receive via the communication device real-time updates relating to the schedule time-relative tasks, and display the real-time updates on the display screen.

Further details and aspects of exemplary embodiments of the present disclosure are described in more detail below with reference to the appended figures.

### BRIEF DESCRIPTION OF THE DRAWINGS

FIG. 1 is a diagram of an exemplary networked environment for incident response, in accordance with aspects of the present disclosure;

FIG. 2 is a diagram of exemplary components of a central server, in accordance with aspects of the present disclosure;

FIG. 3 is an exemplary login screen, in accordance with aspects of the present disclosure;

FIG. 4 is an exemplary screen of incident response templates, in accordance with aspects of the present disclosure;

FIG. 5 is an exemplary screen of a particular incident response template, in accordance with aspects of the present disclosure;

FIG. 6 is an exemplary screen of an incident response task, in accordance with aspects of the present disclosure;

FIG. 7 is an exemplary incident response activation screen, in accordance with aspects of the present disclosure;

FIG. 8 is an exemplary screen of an activated incident response with scheduled tasks, in accordance with aspects of the present disclosure;

FIG. 9 is an exemplary screen for inviting participants and observers to an activated incident response, in accordance with aspects of the present disclosure;

FIG. 10 is an exemplary screen showing an invitation notification, in accordance with aspects of the present disclosure;

FIG. 11 is an exemplary screen showing a received invitation, in accordance with aspects of the present disclosure;

FIG. 12 is an exemplary screen of a mobile device participating in an activated incident response, in accordance with aspects of the present disclosure;

FIG. 13 is an exemplary screen of a mobile device participating in an activated incident response via an Internet browser, in accordance with aspects of the present disclosure;

FIG. 14 is an exemplary screen of a mobile device for interacting with a scheduled task, in accordance with aspects of the present disclosure;

FIG. 15 is an exemplary screen of a mobile device for attaching a file to a scheduled task, in accordance with aspects of the present disclosure;

FIG. 16 is an exemplary screen of a mobile device for recording a video, in accordance with aspects of the present disclosure;

FIG. 17 is an exemplary screen of a mobile device showing a recording attached to a scheduled task, in accordance with aspects of the present disclosure;

FIG. 18 is an exemplary screen showing an update in the central server, in accordance with aspects of the present disclosure;

FIG. 19 is an exemplary screen of a document file interaction, in accordance with aspects of the present disclosure;

FIG. 20 is an exemplary screen showing a document file interaction in a mobile device, in accordance with aspects of the present disclosure;

FIG. 21 is an exemplary screen showing an audit trail button, in accordance with aspects of the present disclosure;

FIG. 22 is an exemplary screen of an audit trail, in accordance with aspects of the present disclosure;

FIG. 23 is an exemplary screen of another portion of the audit trail of FIG. 22, in accordance with aspects of the present disclosure;

FIG. 24 is an exemplary screen showing inactive buttons that an be activated, in accordance with aspects of the present disclosure;

FIG. 25 is an exemplary screen showing activation of a button for group information logging for an incident response, in accordance with aspects of the present disclosure;

FIG. 26 is an exemplary group incident logging screen, in accordance with aspects of the present disclosure;

FIG. 27 is an exemplary screen of a mobile device showing an activated button for group information logging, in accordance with aspects of the present disclosure;

FIG. 28 is an exemplary screen of a mobile device for providing an entry into the group information log, in accordance with aspects of the present disclosure;

FIG. 29 is an exemplary screen of activating a group teleconference for an incident response, in accordance with aspects of the present disclosure;

FIG. 30 is an exemplary screen of a mobile device for accepting a group teleconference invitation, in accordance with aspects of the present disclosure;

FIG. 31 is an exemplary group teleconference management screen, in accordance with aspects of the present disclosure;

FIG. 32 is an exemplary screen for issuing an all clear indication for an incident response, in accordance with aspects of the present disclosure; and

FIG. 33 is an exemplary post-incident response summary, in accordance with aspects of the present disclosure.

### DETAILED DESCRIPTION

The present disclosure relates to a networked environment for incident response. An incident, as used herein, can be any event that requires a coordinated team response and includes, but is not limited to, casualty events such as earthquakes or explosions, localized incidents such as suspicious package or gas leak, organizational events such as labor strike or competitor product launch, and logistical events such as request for pitch or product order, among other things.

Indeed, emergencies can only be effectively managed in real time, but legacy tools do a poor job with real-time creation and sharing of new content or new information relevant for emergency management, such as images and videos, among other information. While legacy tools can define emergency management processes, they are deficient in terms of effectively converting those plans into seamless, coordinated execution flows when a catastrophic event actually occurs, recording the precise sequence of events and artifacts, managing various levels of roles and privilege and other key functionality applicable to the problem at hand. Existing solutions also do not provide or adequately provide combined mechanisms for coordinating the actions of multiple responders, tracking and measuring results, saving associated information, and providing for a post mortem analysis. Other systems not specifically designed for emergency management are sometimes used, but do not contain many of the necessary features for effective communications and coordination in real time among teams with designated roles and responsibilities for following a sequence of tasks. For example, the requirements of effective incident response management are not well met by traditional event-planning, data recording and analysis, or tracking systems, such as Microsoft® Excel®, Atlassian® Jira®, or systems primarily designed to track IT-related incidents.

One aspect of the present disclosure is directed to a central system in the cloud that coordinates and logs communications between team member devices and maintains the status of incident response tasks in real time. Team member devices interact with the incident response tasks and communicate local actions to the central system. The central system aggregates, organizes, and logs the local actions from the team member devices to centrally coordinate the incident response and update the status of the response tasks in real time. Additionally, the central server 200 can be provided with application programming interfaces (APIs) that enable remote systems to receive or transmit data for display or storage for communicating with third party systems and/or to control various functions of the app on one or more remote clients.

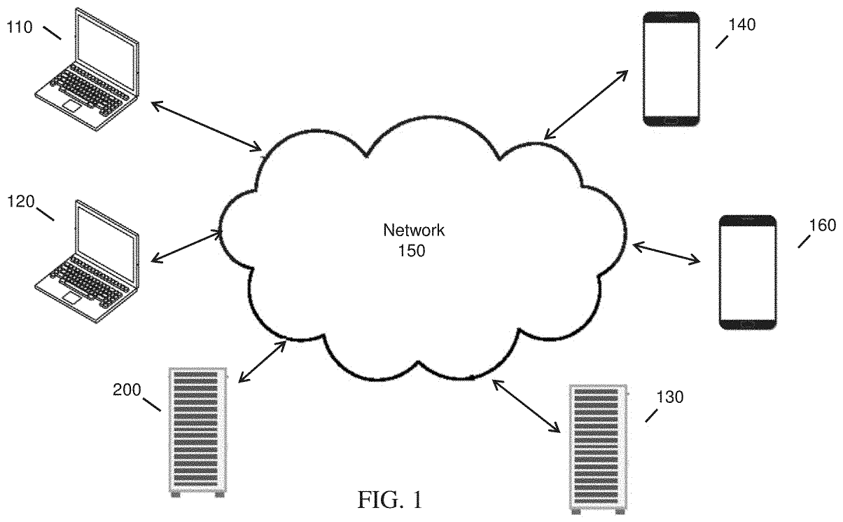

Referring to FIG. 1, there is shown an illustration of an exemplary networked environment 100 in accordance with aspects of the present disclosure. The system 100 includes one or more client computer systems 110, 120, a network 150, a central server 200, and one or more mobile device 140, 160. The mobile device(s) 140, 160 or the client computer system 110, 120 communicate with the central server 200 across the network 150 with regard to an incident response. In various embodiments, the central server 200 may store an incident response template and contact information for an incident response team. In various embodiments, the client computer system 110 and/or the client mobile device 140 can have an app, and the central server 200 can communicate with the app. In various embodiments, the client computer system 120 and/or the client mobile device 160 can have an Internet browser, and the central server 200 can communicate with the Internet browser. The client computer systems 110, 120 and the client mobile devices 140, 160 can utilize various operation systems, including, but not limited to, iOS, Android, Windows, Linux, Symbian, or Blackberry OS, among others.

The term “app” includes a computer program designed to perform particular functions, tasks, or activities for the benefit of a user. App may refer to, for example, software running locally on a user device or remotely, as a standalone program or in a web browser, or other software which would be understood by one skilled in the art to be an app.

In the illustrated embodiment, the networked environment 100 can include one or more third party servers 130. In various embodiments, data, services, or applications from third party servers 130 may be used by the central server 200 and/or the client devices. Such data from third party servers 130 can include, for example, map data, personnel data, floor plans, news feeds, or any other relevant information.

In various embodiments, the central server 200 is provided with application programming interfaces (APIs) that, subject to authentication and verification, enable remote systems to receive or transmit data for display or storage for communicating with third party systems and/or to control various functions of the app on one or more remote clients. APIs are provided to access and customize all relevant areas of function and data. Encryption, data checking, and other security measures are provided to ensure that the APIs are used in the intended manner.

The network 150 may be wired or wireless, and can utilize technologies such as WiFi, Ethernet, Internet Protocol, 3G, and/or 4G, or other communication technologies. The network 150 may include, for example, but is not limited to, a cellular network, residential broadband, satellite communications, private network, the Internet, local area network, wide area network, storage area network, campus area network, personal area network, or metropolitan area network.

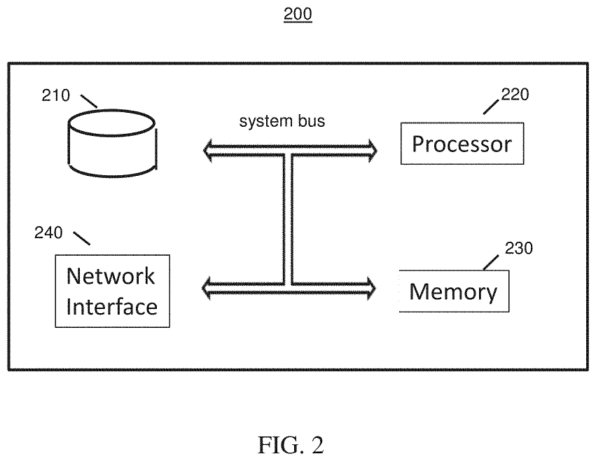

Referring now to FIG. 2, there is shown an illustration of exemplary components in the central server 200 of FIG. 1, in accordance with aspects of the present disclosure. The central server 200 includes, for example, a database 210, one or more processors 220, at least one memory 230, and a network interface 240. In various embodiments, the server 200 can be a proprietary server or can be a hosted server in the cloud, such as a server hosted by Amazon Web Services. In various embodiments, the central server 200 can be a single server can include multiple servers.

The database 210 can be located in an electronic storage. The term “storage” may refer to any device or material from which information may be accessed or reproduced, or held in an electromagnetic or optical form for access by a computer processor. An electronic storage may be, for example, volatile memory such as RAM, non-volatile memory which permanently hold digital data until purposely erased, such as flash memory, magnetic devices such as hard disk drives, and/or optical media such as a CD, DVD, Blu-ray disc, among other storages.

In aspects of the present disclosure, the database 210 can store incident response templates, contact information for an incident response team, and/or login credentials, among other things, which will be explained in more detail later herein. The data can be stored in the server database 210 and sent via the system bus to the processor 220. The system bus can be localized or network-based, and the database need not co-reside with the processor and server memory, as long as all components are in communication with one another.

The processor 220 executes instructions that can be stored in the server memory 230, and utilizes the data from the database 210. With reference also to FIG. 1, the central server 200 can communicate with a user device, such as a mobile device 140 or a client computer 110, through the server's network interface 240. For example, the central server 200 can communicate with an incident response team regarding an activated incident response, which will be described in more detail later herein.

In various embodiments, the central server 200 can send push notifications to a browser or app in the client devices. Users can be notified at the start of an incident response and can be notified of various events during an incident response by way of push notifications. Although not illustrated, it will be understood that client devices can include the architecture and components shown in FIG. 2. Accordingly, a client device can include an electronic storage, a process, a memory, and a network interface, among other things. The processor can execute instructions stored in the memory, including instructions corresponding to an app or instructions corresponding to an Internet browser.

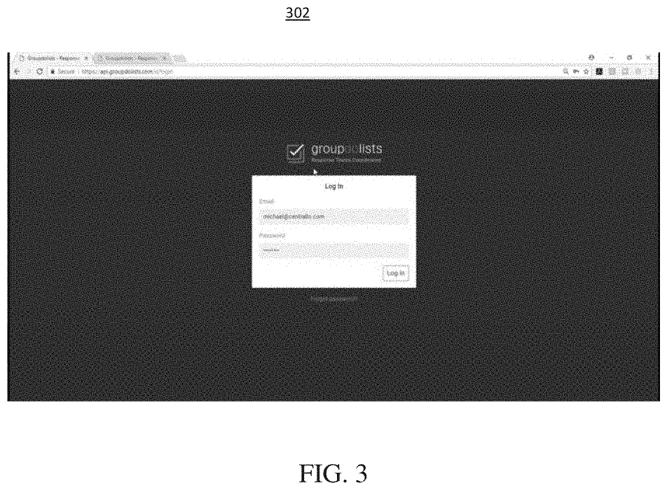

Referring again to FIG. 1, in accordance with aspects of the present disclosure, the client devices 110, 120, 140, 160 can include one device acting as a lead device. The lead device can be any client device running any operating system and communicating with the central server 200 using an app or an Internet browser. Referring also to FIG. 3, there is shown an exemplary login screen 302 of an Internet browser for a user to login into the central server 200. In various embodiments, if the lead device is running an app, the login screen can be a screen for a user to log into the app of the lead device. In various embodiments, if the lead device is running an app, the login screen can also be a screen for a user to log into the central server 200 through the app. In various embodiments, the lead device is determined by the identity and role of the user logged in to the device. Thus, the lead device is not fixed to one particular physical device, although one device at a time typically serves as the lead device.

In various embodiments, the database of the central server (210, FIG. 2) can store a list of authorized organizations, devices, or users, and authentication credentials for members of the list. The central server can allowed members of the list to log into the central server, and can prohibit access to central server by anyone who is not in the list.

The detailed description below and the figures referenced by it may show an Internet browser or a mobile device app, but it is to be understood that such description or figures are merely exemplary. The described and/or illustrated features can be implemented in either or both an Internet browser and a mobile device app, and can be implemented in any mobile or non-mobile computing device.

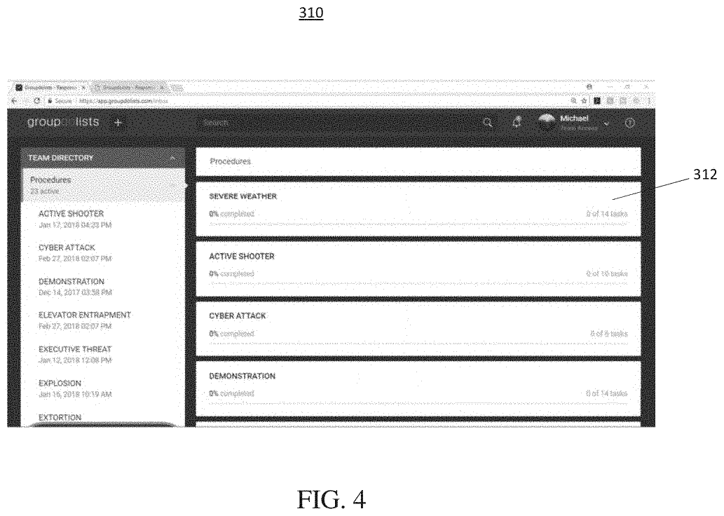

Referring to FIG. 4, there is shown an exemplary screen 310 that can be displayed on a lead device. The screen includes a listing of incident response templates that can be activated by the lead device. An incident response, as used herein, can be a response to any event that requires a coordinated team response and includes, but is not limited to, casualty events such as earthquakes or explosions, localized incidents such as suspicious package or gas leak, organizational events such as labor strike or competitor product launch, and logistical events such as request for pitch or product order, among other things. In various embodiments, each incident response template can be pre-defined and can include tasks to be completed by an incident response team. The incident response team can include any combination of pre-defined listed personnel and personnel whose names are added or invited subsequent to activation. For example, in the illustrated embodiment, the “severe weather” template 312 includes fourteen tasks. In various embodiments, an incident response template can have an unlimited number of tasks. In various embodiments, an incident response template can have a practically unlimited number of tasks (e.g., thousands, or millions), such that even if a template has a limit on the number of tasks, a template would practically never exceed that limit. In various embodiments, the central server 200 can store an unlimited number of incident response templates.

In various embodiments, the central server 200 can include a subscription system for incident response templates. For example, the central server 200 can offer various tiers of templates, such that each tier corresponds to a limited number of templates. In various examples, the central server 200 can provide subscriptions for different groups of incident response templates, such as, without limitation, corporate incident templates, financial incident templates, business incident templates, government incident templates, real-estate incident templates, and/or law enforcement incident templates, among other subscription groups. In various embodiments, the database (210, FIG. 2) can store the subscription tier and/or the templates groups associated with a particular user, and the display screen 310 can display only the number of templates or group(s) of templates corresponding to the particular user. In various embodiments, the templates subscribed to by a user can be supplemented by a user's customized templates. Thus, users can define incident response procedures customized to their group or organization. In various embodiments, the central server 200 can synchronize the templates associated with an organization or a group, which avoids the common problem of organizations or team members having different versions of the incident response procedures on file.

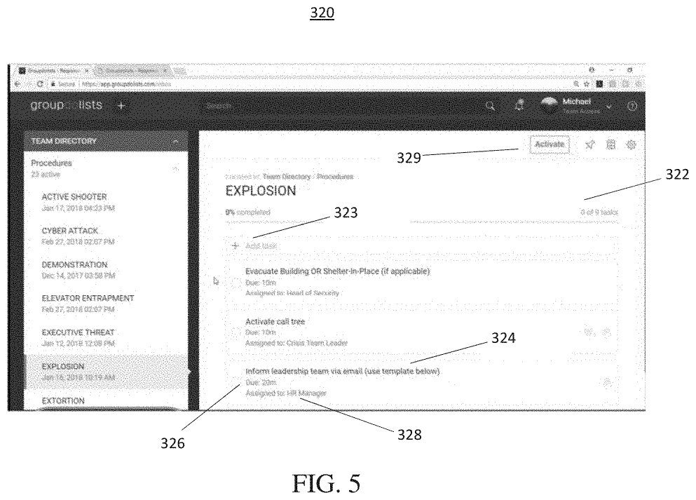

Referring now to FIG. 5, there is shown an exemplary screen 320 of a task list for an explosion incident response template 322 having nine tasks. Three of the predefined tasks are shown, and the other tasks can be display by scrolling the template 322. Additional tasks can be added using the “Add task” button 323. As illustrated, each task includes a task name 324, a time-relative deadline 326, and an assigned role or assigned person 328. The task name 324 can be edited in the template 322 as desired. The time-relative deadline 326 is a deadline that is relative to an incident response activation time. In the illustrated embodiment, the “Inform leadership team via email” task has a twenty-minute deadline, which indicates that it is due twenty-minutes after the time the response template is activated. In various embodiments, the tasks are ordered based on the time-relative deadline 326. In various embodiments, the assigned role or assigned person 328 is chosen from a list of defined roles or list of personnel, which can be stored in the database (210, FIG. 2.) In various embodiments, a task may not have a time-relative deadline 326 and/or may not have an assigned role 328. In various embodiments, if task includes an assigned role or assigned person, the central system 200 can permit the task to be completed only by the particular person or by a person who is assigned the role.

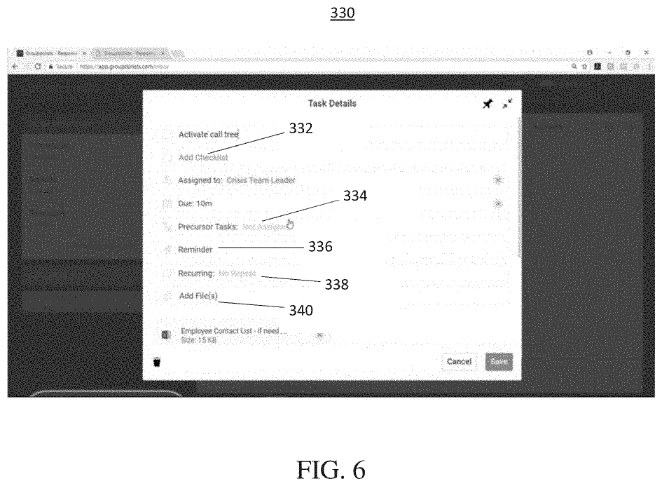

Referring to FIG. 6, there is shown an exemplary screen 330 of a task editing dialog box, which includes spaces for entering the task name, time-relative deadline, and assigned role described in connection with FIG. 5. As shown in FIG. 6, the time-relative deadline and the assigned role can be deleted such that the task may not have those requirements. In the illustrated embodiment, the task editing dialog box additionally includes options to add a checklist 332, define precursor tasks 334, set a reminder 336, set a recurrence 338, and add a file 340. The checklist option 332 allows a task to include sub-tasks that do not have individual deadlines. The precursor task option 334 allows a task to depend on the completion of an earlier task. When a precursor task 334 is specified, the central server 200 and/or the client device can prohibit any user interaction with the dependent task until the precursor task is completed, and can permit user interaction with the dependent task once the precursor task is completed. The reminder option 336 can be used to set an audio, visual, and/or haptic reminder of the task deadline, such as a reminder five minutes before task deadline or another time interval before the task deadline. The recurrence option 338 can be used to provide copies of the task in the template on a regular interval, such as every hour or every day, or another time interval. As an example, “Confirm head count” can be an hourly task after an incident response is activated, and “Hold press meeting” can be a daily task after an incident response is activated. The add file option 340 can be used to attach additional information to the task, such as, for example, an employee contact list Excel file that can be used by the incident response team to confirm that all employees are accounted for. Other types of files can be attached to an incident response task. In various embodiments, the database (210, FIG. 2) can include a list of authorized file types, including, without limitation, a video file, an image file, an audio file, an audiovisual file, a photograph file, and/or a document file, among other file types. The document file can be a Word file, an Excel file, a PowerPoint file, or a PDF file, among other types of document files. The task options shown in FIG. 6 are exemplary, and other options can be available for an incident template task.

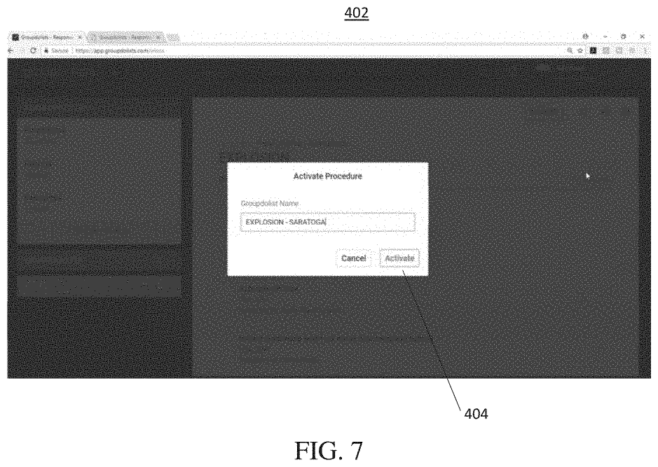

Referring now to FIG. 7, there is shown an exemplary screen 402 on a lead device for activating an incident response template. With reference also to FIG. 5, the screen 320 of incident response templates includes an “Activate” button 329. When the “Activate” button 329 is pressed, the screen 402 for activating the response template is displayed. Activating a response template creates a “live” instance of the response template, and the display screen 402 requests for the user to enter a name for this “live” instance. In the illustrated example, the name of the incident to be activated is “EXPLOSION — SARATOGA.” After the name of the incident is entered, the user can press the “Activate” button 404 on the display screen. In accordance with aspects of the present disclosure, the device that activates an incident response is referred to herein as the lead device. As described above herein, any client device can be the lead device, and the activation at the lead device can be performed through an app or an Internet browser. In accordance with aspects of the present disclosure, the central server 200 receives an indication that the activation button 404 has been pressed on a lead client device, and the central server 200 activates the incident response.

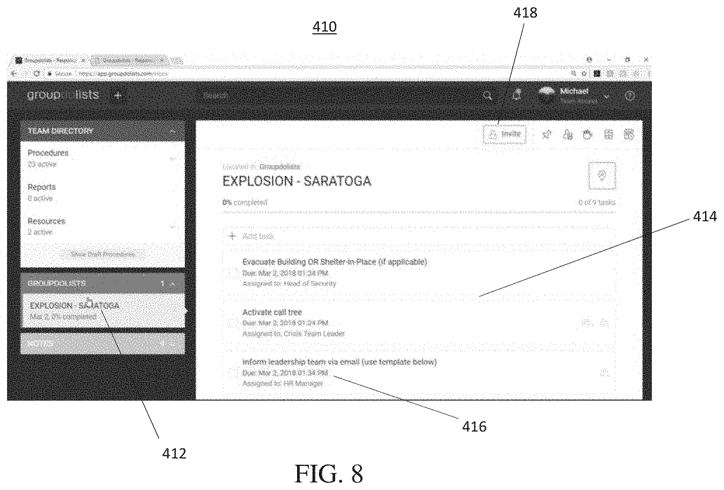

FIG. 8 shows an exemplary screen 410 of an activated incident response, and in particular, of the EXPLOSION—SARATOGA incident response activated in FIG. 7. The activated incident response is added to a list of activated incident responses 412, and the tasks of the activated incident response are scheduled and displayed 414. For example, the “Inform leadership team via email” task had a twenty-minute deadline in the template (FIG. 5) and has been scheduled in the activated incident response with a deadline of twenty-minutes after the activation time. In the illustrated embodiment, the actual deadline 416 for the task is Mar. 2, 2018 at 01:34 PM. This is twenty-minutes after the incident response activation time of 01:14 PM. The display screen 410 also includes an invite button 418 that can be used to invite participants and observers to the activated incident response.

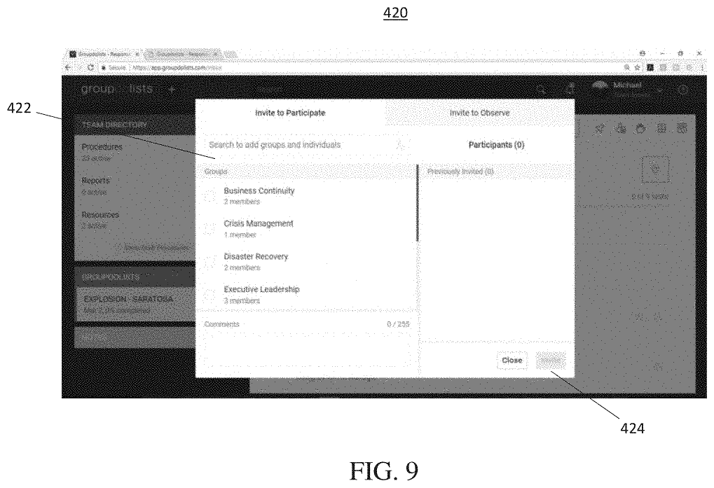

FIG. 9 shows an exemplary display screen 420 for inviting participants and observers to the activated incident response. In various embodiments, the database (210, FIG. 2) includes contact information for members of an incident response team. In various embodiments, the database includes contact information for members of an organization. In various embodiments, the database includes contact information for members of groups 422 within an organization. In various embodiments, contact information can include, without limitation, first and last name, position(s) within an organization, incident response role(s), company telephone number, mobile phone number, VoIP connection information, company email address, personal email address, mobile device ID, and/or app registration information, among other things. In various embodiments, inviting a device to join an activated incident response involves selecting members from the database and pressing the “Invite” button 424 from the lead device. The central server 200 then communicates invitations to the selected members using the contact information for the members in the database. The invitation may be communicated by multiple ways, including, but not limited to, push notification, email, SMS text, voice calling, and other communication technologies.

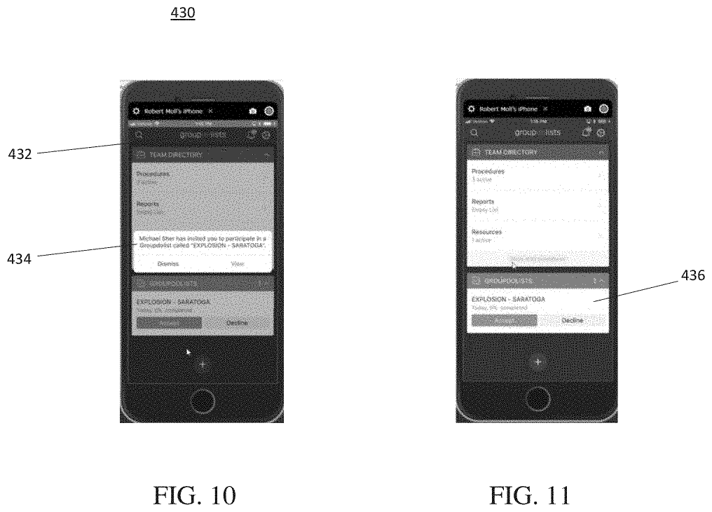

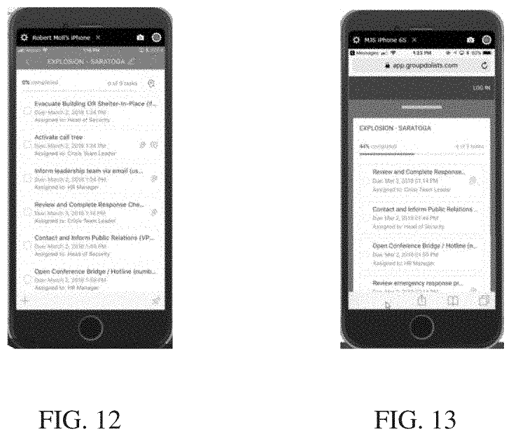

FIG. 10 shows an exemplary screen 430 of a member device that is invited by the central server 200 to join an activated incident response. In various embodiments, the member device includes an app 432 that is configured to communicate with the central server 200. The app 432 and the mobile device can provide a pop-up notification 434 of the invitation, which the user of the device can view or dismiss. When the user selects the view button of the notification 434, the notification closes and the member device focuses in on the invitation 436 to join the activated incident response. Then, when the “Accept” button of invitation 436 is selected, the member device communicates the acceptance of the invitation 436 to the central server 200, which grants the member device access to the activated incident response. FIG. 12 shows an exemplary display screen of the member device in which the device accesses the activated incident response through an app. As described above herein, member devices can access an activated incident response through either or both an app and an Internet browser. FIG. 13 shows an exemplary display screen of the member device in which the device accesses the activated incident response through an Internet browser.

The embodiments described herein and illustrated in the figures are exemplary, and variations are contemplated. For example, in various embodiments, the invitation screen of FIG. 9 can be used to invite anyone to participate in or to observe an activated incident response, including persons who are not members of an incident response team or who are not members of the same organization. In various embodiments, persons for whom there is no contact information in the database of the central server 200 can be invited to participate in or observe an activated incident response by manually entering the contact information of the invitee, such as manually entering a telephone number or an email address of the invitee.

In various embodiments, if the invitee device does not include an app registered with the central server 200, the central server 200 can send an invitation to the invitee device using another communication protocol, such as an SMS message or an email message (not shown). Such a message (not shown) can include an URL that can be selected to launch an Internet browser and provide access to the activated incident response through the Internet browser, as shown in FIG. 13.

Referring now to FIG. 14, there is shown an exemplary screen 502 of a client device in which the client device interacts with a task of the activated incident response. The illustrated screen relates to a task 504 to “Take Photos or Videos of a scene.” In accordance with aspects of the present disclosure, a client device can modify or complete a task locally at the client device, and the modification or completion of the task at the client device can be communicated to the central server 200 in “real-time.” As used herein, “real-time” refers to the timing of communications between the central server 200 and client devices in which transmissions of communications occur at the earliest possible time when a communication channel is available and when the server/device processor is available to direct the communication to the communication channel. In various embodiments, “real-time” may require that no purposeful lags or delays in communications occur between the central server 200 and client devices. In various embodiments, “real-time” may require that a communication channel of sufficient bandwidth and latency be available.

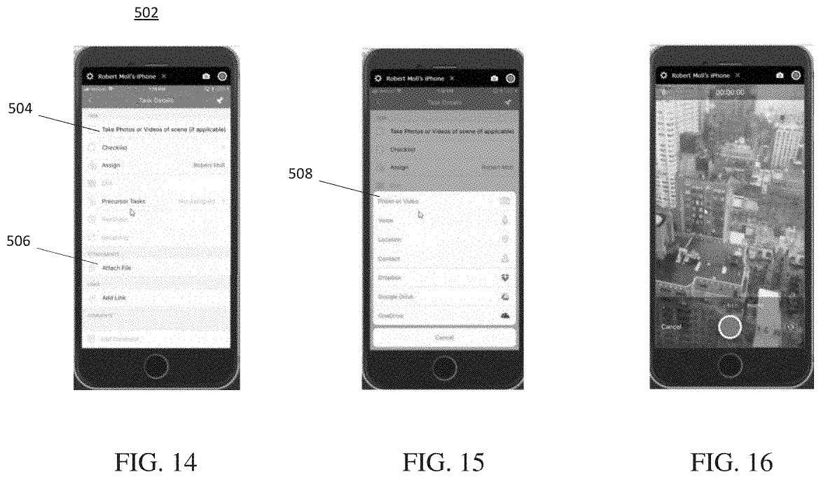

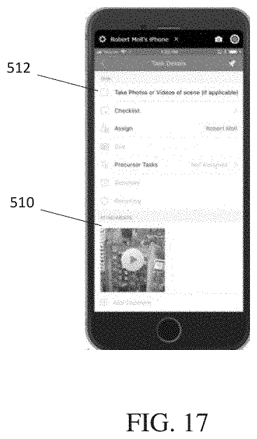

With continuing reference to FIG. 14, the client device can fulfill the task 504 of taking photos or videos of a scene using the built-in functionality of the client device. The user can select the “Attach file” entry 506 of the task screen 502, which can bring up the client device's menu of possible file types that can be attached, as shown in FIG. 15. Selecting the “Photo or Video” entry 508 launches the client device's camera functionality, as shown in FIG. 16, which can be used to take the photo or video of the scene as specified in the task. When the photo or video capture is completed, the client device attaches the file 510 to the task 504. If appropriate, the user can mark the task 504 as completed on the client device by selecting the completion checkbox 512. In various embodiments, the task can indicate whether an attachment, such as photo or video, is required for the task to be designated as completed.

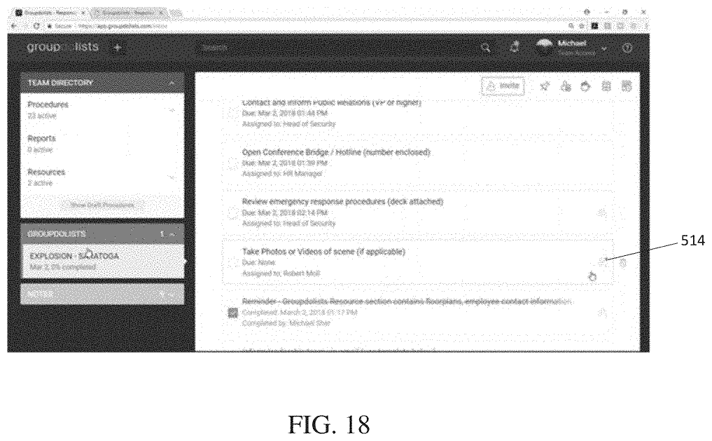

As described above, the modification or completion of a task at the client device can be communicated to the central server 200 in real-time. Thus, when the “Take Photos or Videos of scene” task 504 is modified at the client device to attach a photo or video, the modification is communicated in real-time to the central server 200. The central server 200 receives the update and the attached photo or video, and updates the same task 514 in the central server 200 with the attached photo or video, as illustrated in FIG. 18. The central server then communicates with the devices participating in or observing the activated incident response to update the same task on those client devices.

The embodiments described above are merely exemplary. In various embodiments, other types of files can be attached to a task. In various embodiments, the database (210, FIG. 2) can include a list of authorized file types, including, but not limited to, a video file, an image file, an audio file, an audiovisual file, a photograph file, or a document file, among others. The document file can include a Word file, an Excel file, a PowerPoint file, and a PDF file, among others. In various embodiments, a file can be attached to a task only if it is one of the authorized file types.

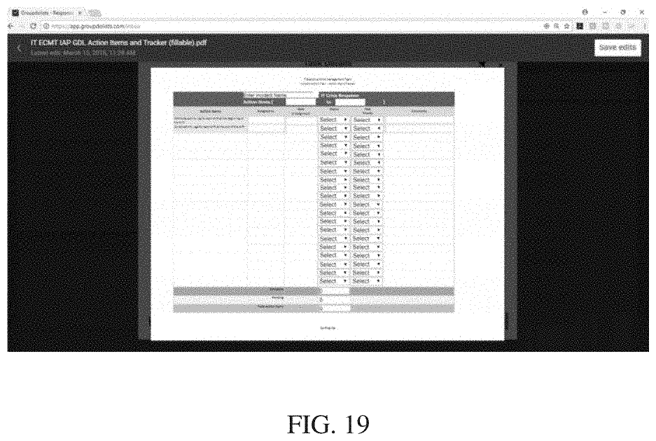

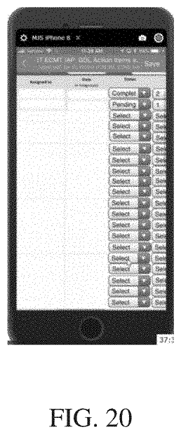

In accordance with aspects of the present disclosure, an app or an Internet browser is configured to support the opening and editing of authorized file types within the app or within an Internet browser without native support for the file type within the client device. For example, referring to FIG. 19, there is shown an exemplary screen of a fillable PDF file accessed by an URL within an Internet browser. The capability to open, edit, and save the PDF file is provided by the central server 200 through the Internet browser, and the client device need not natively support the file type. Accordingly, files that maybe needed to complete a task can be used by any client device without worry about whether the client device supports the file. As shown in FIG. 20, support for authorized file types can be provided within an app of the client device as well.

An audit trail feature of the present disclosure will now be described. In accordance with aspects of the present disclosure, the central server 200 maintains a log of events relating to an activated incident response, including various events occurring at the central server 200 and various events occurring at client devices that are communicated to the central server 200. The log of events is recorded by the central server 200 in the background and can be recorded in the database (210, FIG. 2) of the central server 200. This recorded log of events is referred to herein as an “audit trail.”

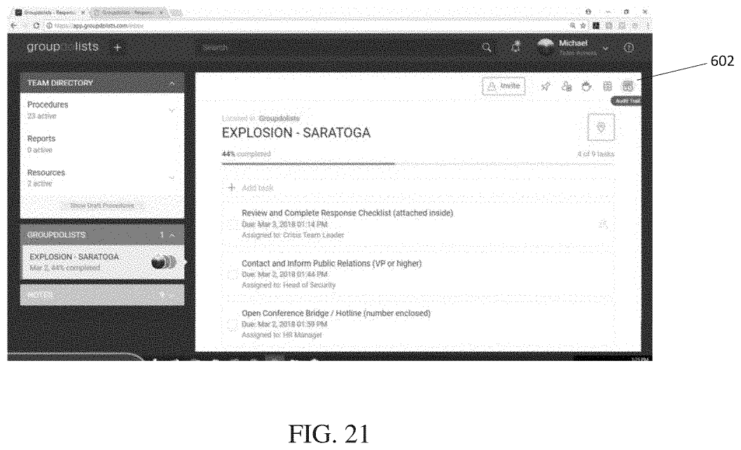

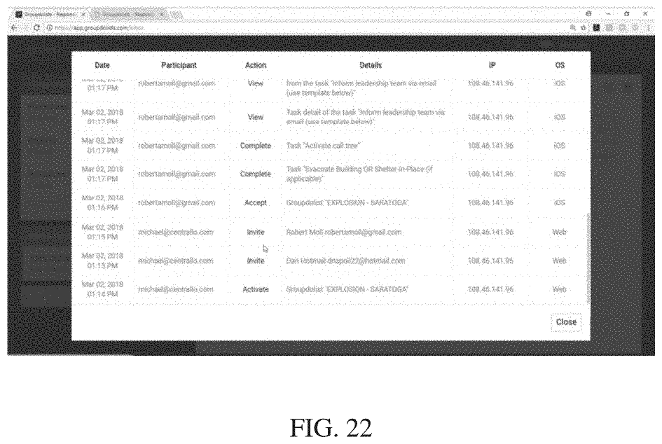

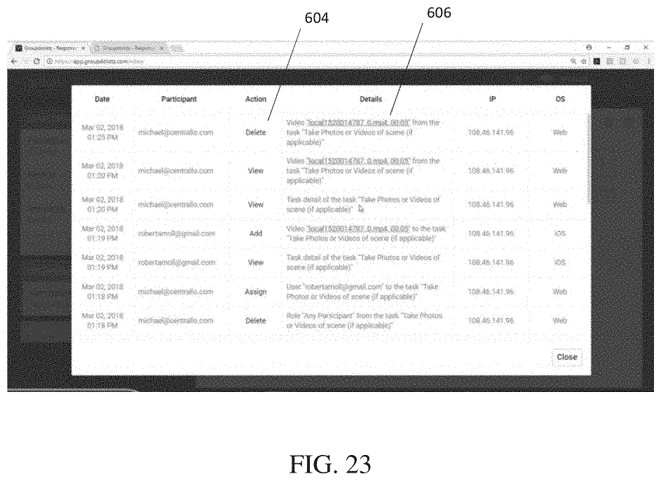

FIG. 21 shows an exemplary screen of the activated incident response of FIG. 8 that includes a button 602 for accessing the audit trail. FIG. 22 and FIG. 23 show portions of the audit trail. As shown in FIG. 22 and FIG. 23, various items of information can be recorded in the audit train, including time of event, participant who triggered the event, the type of event, details regarding the event, IP address of the client device used by the participant, and type of operation system on the client device. In various embodiments, the audit train records a comprehensive record of events, including events such as, without limitation, an activation, invitations, acceptance of invitations, viewing of a task, assigning and deleting roles, adding and deleting attachments, editing a task, and completion of a task, among other events. In accordance with aspects of the present disclosure, and as shown in FIG. 23, a deletion event 604 is recorded by the audit trail, such that information 606 deleted during an activated incident response is not permanently lost. More generally, if a later action negates or partially negates an earlier action, both the earlier action and the later action can be recorded in the audit trail. The audit trail data set can be configured so that it cannot be modified or deleted without special authorization or without an override, and is generally designed for permanent retention.

In various embodiments, when an action occurs at the client devices relating to an activated incident response or a task of an activated response, the client device app or Internet browser generates a time stamp indicating when the action occurred. The time stamp is associated with the action, and the action and time stamp are communicated to the central server 200 and are recorded in the audit trail. Thus, the event date and time shown in the audit trail of FIG. 22 and FIG. 23 and time stamps generated by the client devices where the actions occurred. In various situations, the actions of multiple client devices are simultaneously reported to the central server 200, and the reported actions can arrive at the central server 200 in different order depending on network traffic conditions. The central server 200 can determine a temporal sequence of the actions based on the time-stamps of the actions to sequence the reported actions by time-order, and can then record the sequence of actions in the audit trail.

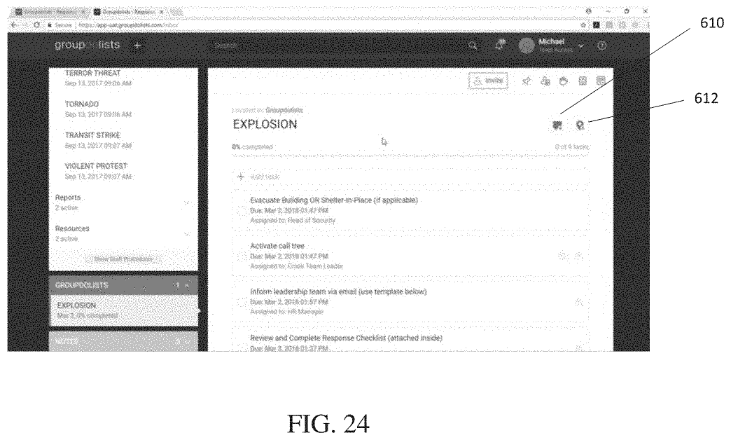

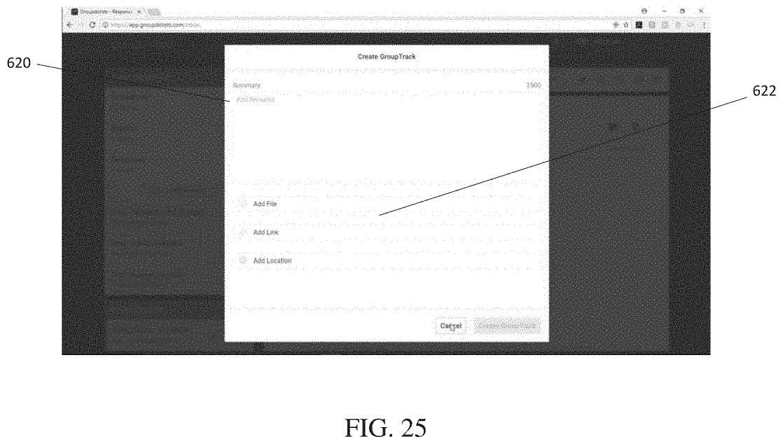

Referring now to FIG. 24, there is shown an exemplary screen of the activated incident response of FIG. 8 that includes buttons 610, 612 for activating enhanced features for an activated incident response. The buttons 610, 612 show a “+” sign, which indicates that the feature is inactive and can be activated. The left button 610 can be selected to activate a group information logging portal for the incident response, which will be described in connection with FIGS. 25-28. The right button 612 can be selected to activate a mapping portal for the incident response. The mapping portal (not shown) enables the client devices to tag information to various locations associated with the client devices by using the native GPS functionality in the client devices. The information logging portal will now be described. In various embodiments, the enhancement buttons 610, 612 can only be activated by the lead device that activated the incident response. In various embodiments, the enhancement buttons 610, 612 can be created by any participant and/or observer of the activated incident response. The mapping portal and group information logging portals are examples of enhancement buttons, but the enhancement button functionality is not limited to these examples.

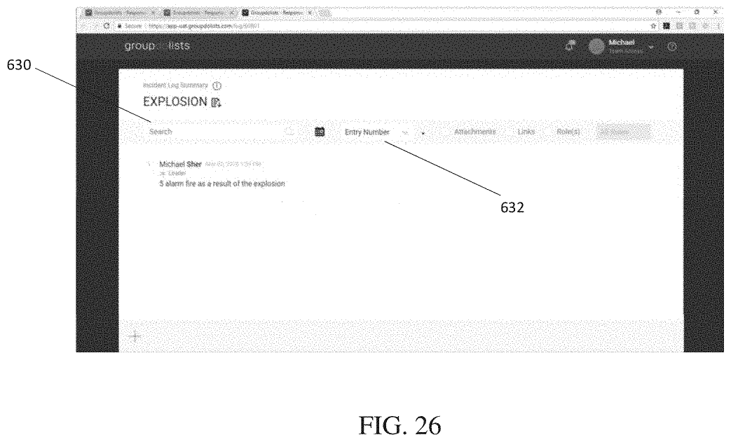

FIG. 25 shows an exemplary screen for creating an information logging portal when the enhancement button 610 of FIG. 24 is selected. The creation screen permits the creator to immediately enter remarks 620 to input into the portal. Additionally, the creator can immediately attach a file, a link, and/or a location 622 to the portal. After the creator enters the desired remarks 620 and/or attaches the desired information 622, the creator can select “Create GroupTrack” to create the information logging portal. FIG. 26 shows an exemplary screen of the information logging portal on the creator's client device.

In the illustrated example of FIG. 26, the creator added remarks “5 alarm fire as a result of the explosion” when creating the portal. As shown in FIG. 26, the information logging portal includes various features, including the capability to search 630 the information entries in the portal, and the capability to sort the information entries 632.

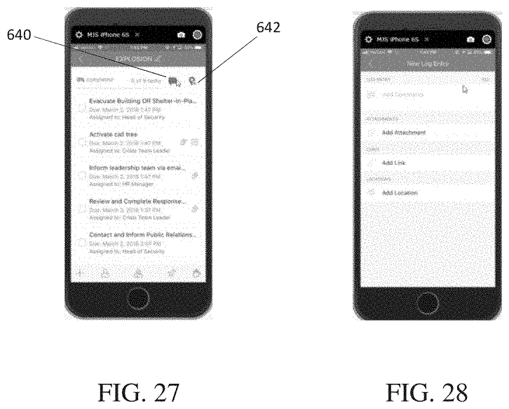

In accordance with aspects of the present disclosure, when an enhancement button is activated, the button become available on all client devices participating in or observing the activated incident response. For example, FIG. 27 shows an exemplary screen of a client device participating in the activated incident response. As shown in FIG. 27, the button 640 for accessing the information logging portal no longer has a “+” sign, which indicates that the feature has been activated. However, the map enhancement button 642 still includes the “+” sign, which indicates that the features has not yet been activated. The client device can select the activated button 640 to access the information logging portal. FIG. 28 shows an exemplary screen of the client device for entering a log entry into the activated information logging portal.

In various embodiments, information entered into the information logging portal from any client device can be communicated in real time to the central server 200, which updates the information logging portal with the new entries. The central server 200 communicates the new entries to all client devices in real time so that the information logging portal serves as a real-time information sharing portal.

Referring again to FIG. 24, the right button 612 can be selected to activate a mapping portal for the incident response. The mapping portal (not shown) enables the client devices to tag information to various locations associated with the client devices by using the native GPS functionality in the client devices. In accordance with aspects of the present disclosure, the central server 200 can provide the mapping portal functionality. As with the information logging portal, the mapping portal provides a shared portal for accessing real time information that is maintained by the central server 200 and that is accessible to client devices. In contrast with the information logging portal, the mapping portal provides the real time information in a geographical format.

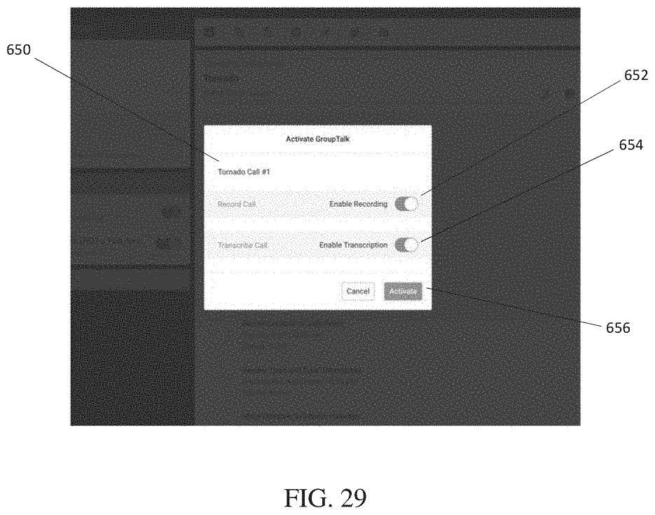

With continuing reference to FIG. 24, in various embodiments, the enhancement buttons can include a button (not shown) to activate a teleconference portal. FIG. 29 shows an exemplary screen for creating and activating the teleconference portal. The creation screen includes a space 650 for naming the portal and includes options for the portal. One option 652 enables the conversation in the portal to be recorded, and another option 654 enables automatic machine transcription of the conversation in the portal. In accordance with aspects of the present disclosure, the central server 200 can provide the teleconference portal functionality. In various embodiments, speech recognition technology at the central server 200, such as machine learning technology, can be used to automatically transcribe conversation on the teleconference portal. In various embodiments, various technology at the central server 200 can record conversation on the teleconference portal, including technology for sampling voice signals and for recording digitized voice information.

The “activate” button 656 of the teleconference portal creation screen can be selected to create the portal. In various embodiments, only the lead device which activated the incident response can create the teleconference portal. In various embodiments, any participant or observer of the activated incident response can create the teleconference portal. When the central server 200 receives an indication from a client device or the lead device that a teleconference portal has been created, the central server 200 can initiate calls to the client devices. In various embodiments, the calls can be initiated as voice-over-IP (VoIP) calls. In various embodiments, the calls can be initiated as voice calls over a voice network. In various embodiments, the calls can be initiated to various recipients as a combination of both VoIP and voice calls, as required to reach each recipient.

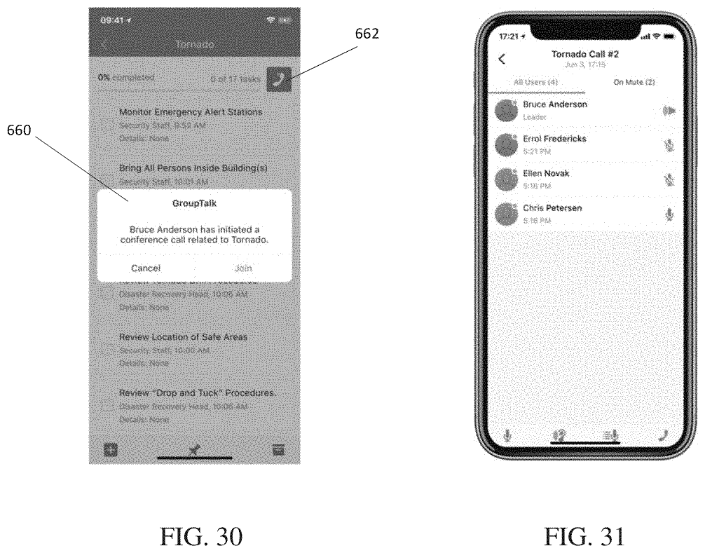

FIG. 30 shows an exemplary screen of a client device that receives a teleconference portal call initiated by the central server 200. In the illustrated embodiment, the client device includes an app registered with the central server 200, and the app can provide a notification 660 of the incoming teleconference portal call. A user can join the teleconference by selecting “Join” in the notification 660. If the user is not available to join, the user can select the “Cancel” button in the notification 660. The user can later join the teleconference portal as desired by selecting the teleconference portal button 662.

FIG. 31 shows an exemplary display screen of an activated teleconference portal, in which all participants in the teleconference portal are listed. In various embodiments, the display screen is a screen of the lead device and/or of the device which activated the teleconference portal. In various embodiments, the display screen can be a display screen of any client device participating in the teleconference portal.

In various embodiments, the central server 200 can maintain the teleconference portal as long as the incident response remains active. In various embodiments, client devices participating in or observing the activated incident response can join or drop off the teleconference portal as desired while the teleconference portal is active. In various embodiments, if the client device does not include an app registered with the central server 200, the client device can receive a SMS message or email message with information for dialing into the teleconference portal.

Accordingly, described above are enhancement buttons that can be activated to provide additional functionality and real-time information sharing for an activated incident response. In various embodiments, the enhancements can be provided by the central server 200 on a subscription basis. For example, certain subscription levels may include the information logging portal, but not the mapping portal or the teleconference portal. In various embodiments, certain subscription levels can include some or all of the portal enhancements.

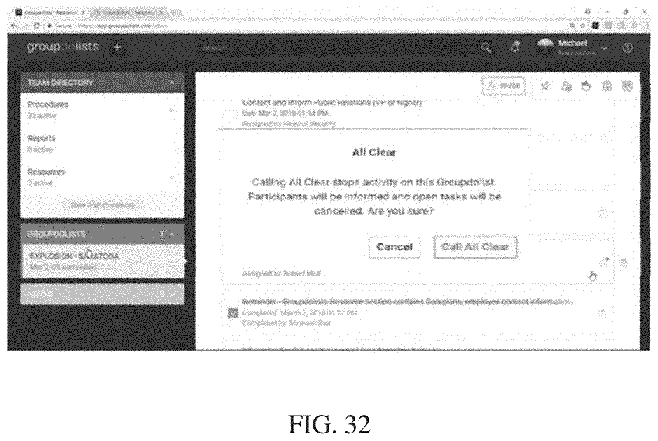

Referring now to FIG. 32, when an incident response is completed, the incident response can be closed down. FIG. 32 shows an “All Clear” screen that can be used to close down an activated incident response. In various embodiments, only the lead device which activated the incident response can close down the incident response. In various embodiments, multiple members of an incident response team or of an organization may have assigned roles that enable and authorize them to close down an incident response. If the “Call All Clear” button is selected, the central server 200 can indicate to each client device that the incident response is over. In various embodiments, as necessary, the act of closing down the incident response may also terminate the teleconference portal associated with the response.

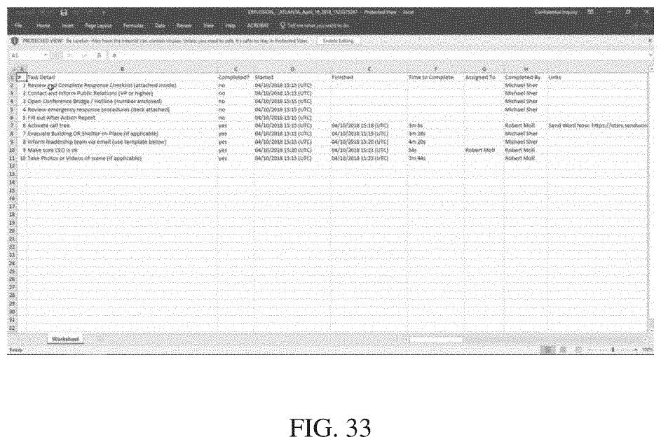

In accordance with aspects of the present disclosure, the central server 200 can provide an incident response summary report after an incident response is over. FIG. 33 shows a screen of an exemplary incident response summary report, which includes information such as amount of time taken to complete each task of the incident response, and each task was completed or not completed. The illustrated embodiment is merely exemplary, and variations are contemplated to be within the scope of the present disclosure. For example, the summary report can include any of the data or information described herein and is not limited the information shown in FIG. 33.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database systems and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The systems described herein may also utilize one or more controllers to receive various information and transform the received information to generate an output. The controller may include any type of computing device, computational circuit, or any type of processor or processing circuit capable of executing a series of instructions that are stored in a memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, causes the one or more processors to perform one or more methods and/or algorithms.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A central system for incident response, the central system comprising:
an electronic storage storing information including:
an incident response template having time-relative tasks, and contact information for an incident response team;
a communication device configured to communicate with a plurality of devices corresponding to at least some of the contact information, the plurality of devices including a lead device and a plurality of mobile devices;
one or more processors; and
at least one memory storing instructions which, when executed by the one or more processors, cause the central system to:
receive, via the communication device, an activation of the incident response template from the lead device at an activation time,
schedule an activated incident response based on the activation of the incident response template, wherein scheduling the activated incident response includes scheduling the time-relative tasks based on the activation time, and
communicate, via the communication device, with the plurality of mobile devices regarding the activated incident response.

2. The central system of claim 1, wherein the instructions, when executed by the one or more processors, further cause the central system to:
invite the plurality of mobile devices to join the activated incident response;
receive confirmation that the plurality of mobile devices has joined the activated incident response; and
communicate with the plurality of mobile devices regarding the scheduled time-relative tasks.

3. The central system of claim 2, wherein at least one mobile device of the plurality of mobile devices joins the activated incident response as a participant, wherein the instructions, when executed by the one or more processors, further cause the central system to:
receive, from the at least one mobile device, at least one action at the at least one mobile device relating to the scheduled time-relative tasks;
update, in real-time, the activated incident response based on the at least one action at the at least one mobile device; and
communicate, in real-time, the updated activated incident response to the plurality of mobile devices.

4. The central system of claim 3, wherein the at least one action includes attaching a file to a task of the scheduled time-relative tasks at the at least one mobile device, and wherein:
receiving the at least one action includes receiving the file;
updating the activated incident response includes storing, in the electronic storage, the file and an association of the file with the task; and
communicating the updated activated incident response includes communicating, to the plurality of mobile devices, the file and the association of the file with the task.

5. The central system of claim 4, wherein the electronic storage includes a list of authorized file types including at least one of a video file, an image file, an audio file, an audiovisual file, a photograph file, or a document file, wherein the file is of a type included in the list.

6. The central system of claim 3, wherein the at least one action includes at least one of:
designating, at the at least one mobile device, at least one of the schedule time-sensitive tasks as being completed, or
incorporating information about performance or outcome into at least one of the schedule time-sensitive tasks.

7. The central system of claim 2, wherein the invitation is an invitation to observe, and wherein at least one mobile device of the plurality of mobile devices joins the activated incident response as an observer in response to the invitation to observe.

8. The central system of claim 1, wherein the instructions, when executed by the one or more processors, further cause the central system to:
communicate with the plurality of mobile devices regarding the scheduled time-relative tasks; and
receive, from the plurality of mobile devices, actions at the plurality of mobile devices relating to the scheduled time-relative tasks,
wherein the received actions include time-stamps indicating times at which the actions occurred at the plurality of mobile devices, the time-stamps being provided by the plurality of mobile devices.

9. The central system of claim 8, wherein the instructions, when executed by the one or more processors, further cause the central system to:
determine a temporal sequence of actions relating to the scheduled time-relative tasks based on the time-stamps of the actions; and
store, in the electronic storage, the temporal sequence of actions.

10. The central system of claim 9, wherein the temporal sequence of actions includes an earlier action and a later action that at least partially negates the earlier action, wherein both the earlier action and the later action are stored in the electronic storage as part of the temporal sequence of actions.

11. The central system of claim 1, wherein the instructions, when executed by the one or more processors, further cause the central system to:
receive from the lead device, via the communication device, an activation of a previously inactive user interface button for the activated incident response; and
communicate, via the communication device, with the plurality of mobile devices regarding the activated user interface button for the activated incident response.

12. The central system of claim 11, wherein the activated user interface button is a map access button.

13. The central system of claim 11, wherein the activated user interface button is a group information logging portal button.

14. The central system of claim 1, wherein the instructions, when executed by the one or more processors, further cause the central system to:
receive from the lead device, via the communication device, an activation of a teleconference for the activated incident response;
initiate a teleconference including the lead device;
initiate voice calls to the plurality of mobile devices using the contact information; and
add to the teleconference any mobile devices of the plurality of mobile devices which answer the voice calls.

15. The central system of claim 14, wherein the instructions, when executed by the one or more processors, further cause the central system to:
record audio conversation in the teleconference;
convert the audio conversation into a text transcription of the audio conversation using machine transcription; and
store the text transcription of the audio conversation in the electronic storage.

16. The central system of claim 14, wherein the instructions, when executed by the one or more processors, further cause the central system to:
maintain the teleconference as long as the activated incident response remains activate; and
permit teleconference participants to join and drop off the teleconference while it is maintained.

17. The central system of claim 1, wherein the time-relative tasks include a precursor task and a dependent task that depends on the precursor task, wherein the instructions, when executed by the one or more processors, further cause the central system to:
prohibit any user interaction with the dependent task until the precursor task is completed; and
permit user interaction with the dependent task when the precursor task is completed.

18. The central system of claim 1, wherein the electronic storage further includes roles and privileges associated with members of the incident response team, wherein each of the time-relative tasks is associated with at least one of: a particular role or a particular person, and wherein the instructions, when executed by the one or more processors, further cause the central system to permit the time-relative tasks to be completed only by the particular persons or by members of the incident response team who are associated with the particular roles associated with the time-relative tasks.

19. The central system of claim 1, wherein the electronic storage further includes a list including at least one of: authorized organizations, devices, or users, and authentication credentials for members of the list,
wherein the instructions, when executed by the one or more processors, further cause the central system to prohibit access to the activated incident response by anyone who is not included in the list.

20. A mobile apparatus for incident response, the mobile apparatus comprising:
a display screen;
a communication device;
an electronic storage storing a mobile app configured to communicate with an incident response central system using the communication device;
one or more processors; and
at least one memory storing instructions corresponding to the mobile app, wherein the instructions, when executed by the one or more processors, cause the mobile apparatus to:
receive, via the communication device, an invitation from the central system to join an activated incident response as a participant,
send, via the communication device, an acceptance of the invitation;
receive, via the communication device, scheduled time-relative tasks corresponding to the activated incident response; and
display the scheduled time-relative tasks on the display screen.
